(19) United States
(12) Patent Application Publication
(10) Pub. No.: US 2013/0049883 A1
(43) Pub. Date: Feb. 28, 2013

(54) WAVEGUIDE NETWORK

(71) Applicants: Yu Gang MA, Singapore (SG); Ching Biing Yeo, Singapore (SG); Hisashi Masuda, Singapore (SG); Yaqiong Zhang, Tempe, AZ (US)

(72) Inventors: Yu Gang MA, Singapore (SG); Ching Biing Yeo, Singapore (SG); Hisashi Masuda, Singapore (SG); Yaqiong Zhang, Tempe, AZ (US)

(73) Assignee: Sony Corporation, Tokyo (JP)

(21) Appl. No.: 13/588,617

(22) Filed: Aug. 17, 2012

(30) Foreign Application Priority Data
Aug. 26, 2011 (SG) 201106262-7

(51) Int. Cl. H01P 5/12

(52) U.S. Cl. 333/137

(57) ABSTRACT

Conventional technologies using copper tracks to couple integrated circuits (ICs) disposed on printed circuit boards (PCBs) face limitations in scaling beyond a certain transmission rate, restricting their future applications. Described herein is a waveguide network, in which the network comprises ICs on a PCB coupled via a dielectric waveguide, which advantageously overcomes these limitations. The dielectric waveguide is able to transmit radio frequency (RF) signals and has a bandwidth of at least 100 GHz, among other features. Further, the network can be arranged with different topologies such as ring, star or bus based, and is also couplable to other equivalent networks on the PCB using suitable waveguide-based networking devices.

### CROSS-REFERENCE TO RELATED APPLICATIONS

This application claims the benefit of priority under 35 U.S.C. §119 from Singapore Patent Application Number 201106262-7, filed on Aug. 26, 2011. The entire contents of the above application are incorporated herein by reference.

### FIELD OF INVENTION

The embodiments of the invention relate generally to waveguide networks. Particularly, but not exclusively, the embodiments of the invention disclose an apparatus and method in which integrated circuits, mounted on printed circuit boards, are interconnected using dielectric waveguides.

### BACKGROUND

The adoption of multi-functional digital devices, such as smartphones and tablets, has proliferated in recent years to the point where smartphones and tablets have now grown to be an indispensable part of our daily lives. As a result, there are demands from the consumers for smartphone and tablet devices to be constantly improved with regard to form factor, better data transfer speed, longer battery life and the like.

Conventionally, smartphone and tablet devices are configured with integrated circuits (ICs) disposed on printed circuit boards (PCBs), and electrically interconnected via copper-based signal traces (i.e. copper tracks) laminated onto the substrate of the PCBs. Each track is configured to be co-shared as a signal channel between designated ICs, similar to the concept of sharing of a physical communication channel in computer networks. For example, in the Ethernet standard, a physical channel may be implemented using twisted copper wires or optical fibres to linkup devices such as PC terminals or standalone modules, which usually have Layer One (i.e. physical layer) and Layer Two (i.e. data link layer) communication capabilities.

Nevertheless, specific challenges abound with using copper tracks for these purposes. For instance, there is a limit to the maximum data rate (between the ICs) that can be achieved using copper tracks because of the non-liner scaling characteristics in relation to data rate, arising due to frequency dependent losses (e.g. return loss, inter-symbol interference or crosstalk). To compensate for signal impairments due to those losses, equalizers are incorporated to ensure that the link performance is met. Equalizers however consume additional power. Moreover, the losses increase as the date rate increases, which further entails use of stronger equalizers (thereby drawing more power) to ensure the same performance, forming a vicious cycle.

Therefore, in light of the foregoing problems, an improved apparatus and method for interconnecting ICs on printed circuit boards would thus be useful and advantageous in the art.

### SUMMARY

According to a first aspect of embodiments of the present invention, there is provided a waveguide network or waveguide bus comprising a substrate having a plurality of integrated circuits disposed thereon, and a dielectric waveguide on or in the substrate. The plurality of integrated circuits are coupled via the dielectric waveguide.

The substrate may be a printed circuit board. Each integrated circuit may be coupled to the dielectric waveguide using a waveguide coupler, which is preferably configured as a planar horn antenna. The antenna may be advantageously arranged to be relatively compact, and to exhibit high gain, directivity, and acceptable losses over most of the intended operating frequency range.

The dielectric waveguide may be configured for transmission of radio frequency signals and may permit the signals to be transmitted concurrently and/or serially. Preferably, transmission may be carried out using Carrier Sense Multiple Access (CSMA) protocol or Frequency Division Multiple Access (FDMA) scheme. In addition, the dielectric waveguide may have a bandwidth of at least 100 GHz.

Further, the dielectric waveguide may also be arranged to interconnect the plurality of integrated circuits to form a network, which may be configured to have a ring topology, a star topology or a bus topology. Moreover, the network may also be communicably couplable to other equivalently configured networks on the substrate using network bridges. Each network bridge is preferably a passive waveguide component arranged as an inter-coupled waveguide or an end-coupled waveguide. Network bridges are advantageous for interconnecting diverse networks as they provide collision domains isolation via micro-segmentation, and enable bandwidth scaling as the network expands.

A network hub, preferably comprising a waveguide resonator for signal amplification, may be disposed on the substrate for interconnecting the plurality of integrated circuits, when the network is configured as the tree topology.

In addition, the dielectric waveguide may comprise a plurality of discrete sections and at least one junction having a plurality of gaps where the discrete sections congregate. The width of each gap is preferably approximately ten percent of the wavelength of a signal frequency transmitted through the dielectric waveguide. This gap feature may improve overall transmission performance by reducing return and signal losses.

According to a second aspect of the embodiments of the present invention, there is provided a waveguide network or waveguide bus comprising a printed circuit board having a plurality of integrated circuits disposed thereon, and a dielectric waveguide on or in the printed circuit board. The plurality of integrated circuits are coupled via the dielectric waveguide.

According to a third aspect of the embodiments of the present invention, there is provided a dielectric waveguide configured to be attached to the surface of, or integrated into, a substrate, the dielectric waveguide comprising a first end arranged to be connectable to an integrated circuit disposed on the substrate, and a second end arranged to be connectable to another similar dielectric waveguide.

These and other aspects of the embodiments of the invention will be apparent from and elucidated with reference to the embodiments described hereinafter.

### BRIEF DESCRIPTION OF THE DRAWINGS

Embodiments of the invention are disclosed hereinafter with reference to the accompanying drawings, in which:

FIG. 1 is a illustration showing a prototype waveguide network implemented on a printed circuit board according to a first embodiment of the invention;

FIG. 2 illustrates a top view of an IC-to-waveguide coupler (i.e. waveguide coupler) used in the network of FIG. 1;

FIGS. 3A to 3E show a conventional Y-junction and a slotted Y-junction used in the network of FIG. 1, together with their associated performance charts;

FIG. 4 illustrates a second embodiment of a waveguide network according to the embodiments of the invention, wherein the network is arranged as a ring topology;

FIG. 5 illustrates a third embodiment of a waveguide network according to the embodiments of invention, wherein the network is arranged as a star topology and includes a network hub;

FIG. 6 illustrates the network hub in FIG. 5, which incorporates a waveguide resonator for signal amplification;

FIG. 7 illustrates a hybrid network, which comprises the waveguide networks of FIGS. 1, 4 and 5 inter-coupled via network bridges;

FIG. 8 illustrates a network bridge used in the hybrid network of FIG. 7, which is configured as an inter-coupled passive waveguide component; and

FIG. 9 illustrates another network bridge used in the hybrid network of FIG. 7, which is configured as an end-coupled passive waveguide component.

### DETAILED DESCRIPTION

Embodiments of the present invention, as described hereinafter, relate to using dielectric waveguides to provide a radio frequency (RF) based waveguide network or waveguide bus on substrates or printed circuit boards (PCB). Specifically, the dielectric waveguide interconnects several integrated circuits (ICs) that are disposed (i.e. mounted) on the PCB to form a network. The embodiments of the invention may find application in areas where there is a need for ultra high-speed inter-IC communication. Each IC has a waveguide coupler (which may be integrated with the IC, integrated into the PCB or mounted as a separate component) to couple the IC to the dielectric waveguide. The waveguide coupler enables signals to be transmitted to and/or received from the dielectric waveguide. The signals may be transmitted concurrently or serially, based on known transmission techniques and protocols.

Some advantages of a network formed using a waveguide bus include enabling high data exchange rates between the ICs, reducing power consumed by the devices (due to the excellent low channel loss characteristic of the dielectric waveguide), reducing manufacturing costs through use of low cost dielectric material for the bus channel (as it eliminates the need for costly and messy copper-based signal traces), and allowing realization of a more compact device form factor for a device (as it simplifies the interface coupling between the ICs and waveguide bus).

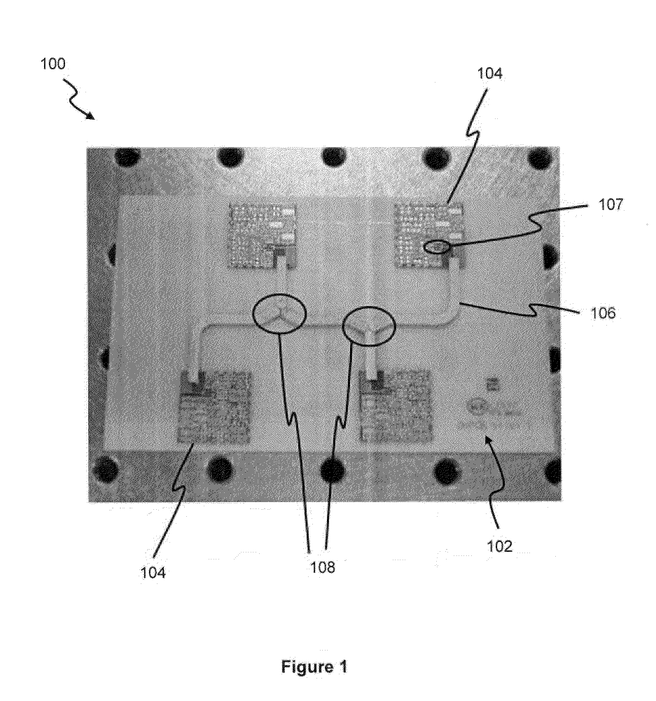

FIG. 1 illustrates a waveguide network 100 arranged on a PCB 102 according to a first embodiment of the invention. Particularly, the waveguide network 100 comprises a plurality of integrated circuits (i.e. ICs) 104 connected via a dielectric waveguide (or waveguide path) 106 through being coupled at different ends/ports of the waveguide 106. The IC 104 may also comprise a plurality of sub IC packages (or IC dies) 107. In an exemplary embodiment, the ICs 104 and the dielectric waveguide 106 are preferably attached to the surface of the PCB 102 using surface-mount technology known in the art. Optionally, the dielectric waveguide 106 can be formed intermediate to the layers of the PCB 102 to reduce the actual space required, and to allow further miniaturization of the size of the PCB 102. Therefore, it is advantageous that the dielectric waveguide 106 has a cross section that is rectangular (i.e. substantially planar), semicircular or any geometric shape (all not shown) that would permit easy adhesion or attachment of the dielectric waveguide 106 to the surface of the PCB 102.

The dielectric waveguide 106 is fabricated by way of one of the following processes: printing, injection stamping, etching, or attaching prefabricated waveguide components to the PCB 102.

The dielectric waveguide 106 essentially serves as a bus (i.e. providing a shared medium channel) to facilitate data transfer between various ICs 104 and is preferably configured to permit concurrent and/or serial data (i.e. signals) communication. Hence, all ICs 104 are designed or programmed for dual transmission modes, serial and concurrent. The ICs 104 may optionally be programmed for a specific transmission mode, depending on the prior configuration of the dielectric waveguide 106. Furthermore, the waveguide 106 is configured with a bandwidth of at least (or exceeding) 100 GHz.

An exemplary method for performing serial transmission may be similar to that of the Media Access Control (MAC) protocol, Carrier Sense Multiple Access (CSMA) as known in the art. Optionally, other suitable protocols such as CSMA with Collision Detection (CD) or Token Ring technology can also be adopted. Applying the corresponding concept to the current context, all ICs 104 will be pre-assigned with a common frequency for transmission in the same network bandwidth. A carrier sensing mechanism is implemented in which, before every transmission, each IC 104 checks if there are any existing data transmissions on the dielectric waveguide 106. If no activity is detected (i.e. implies that the dielectric waveguide 106 is free), an IC 104 commences signal transmission. However, any IC 104 that detects another signal while transmitting a data frame (i.e. a RF signal) is required to immediately stop transmission and instead transmit a jam signal. Subsequently, the IC 104 waits for a random time interval before retransmitting the previous data frame. Each IC 104 adheres to the above steps of the protocol to serially transmit signals.

For concurrent transmissions, the Frequency Division Multiple Access (FDMA) scheme based on the Frequency-Division Multiplex (FDM) technique may preferably be adopted. Under this scheme, each pair of associated ICs 104 is allocated a unique frequency band as the designated transmission frequency. Alternatively, the plurality of ICs 104 may be subdivided into several subgroups (not shown) and each subgroup is assigned a distinct frequency band. Communication within members of each subgroup may (optionally) adopt the serial transmission method as afore described. It is to be appreciated that allocation of different frequency bands under this scheme for different pairs of ICs 104 or subgroups may easily be realizable due to the large bandwidth available (i.e. equal to or greater than 100 GHz). Further, the allocated frequency bands are distinctively separated from neighboring bands to prevent signal interference due to crosstalk. Therefore, independent of any ongoing transmissions over the dielectric waveguide 106, each pair of ICs 104 or subgroup is able to promptly and reliably exchange data without the constraints of serial transmission.

The network 100, as shown in FIG. 1, is organized as a bus-topology (although not limited to this arrangement, as seen in the embodiments described below). Each IC 104 preferably communicates to other ICs 104 using radio frequency (RF) signals transmitted or received over the dielectric waveguide 106. Alternatively, signal communication between the ICs 104 may also be carried out in any desired range of frequencies of the electromagnetic spectrum. Consequently, depending on the adopted communicating frequency for the network 100, a suitable material (i.e. with matching characteristics for specific signal propagation) that enables transmission via the selected frequency is used to form the dielectric waveguide 106.

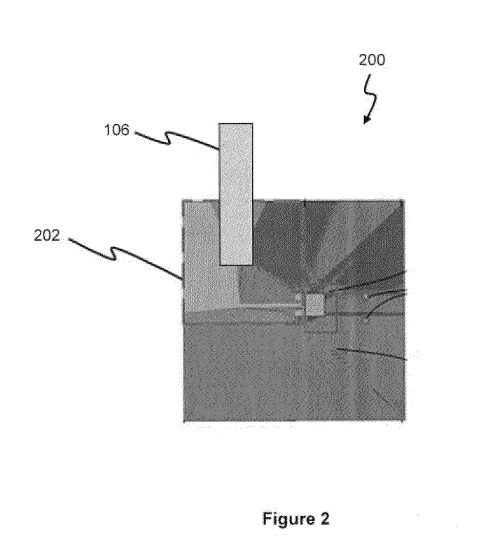

Each IC 104 additionally interfaces with the dielectric waveguide 106 at the respective ports using an IC-to-waveguide coupler (i.e. waveguide coupler) 200, which is illustrated in FIG. 2. The waveguide coupler 200 may be integrally formed as part of each IC 104 (e.g. integrated into the interposer of the IC 104), integrated into the PCB or alternatively made available as an external add-on component. The determination of the particular form factor of the waveguide coupler 200 to adopt depends on the demands of a specific application. In one preferred embodiment, the waveguide coupler 200 comprises an ultra wideband transverse-electromagnetic-mode (TEM) planar horn antenna 202 as depicted in FIG. 2. Particularly, each IC 104 is attached to the planar horn antenna 202 by bonding to the Ground-Signal-Ground (GSG) pads (not shown) of the waveguide coupler 200 by using bonding wires. Signals can then be transmitted through the planar horn antenna 202 to an associated dielectric waveguide 106 connected thereto. The tolerance for aligning an end portion of the dielectric waveguide 106 attached to the planar horn antenna 202 is substantially large (according to one embodiment), such that the dielectric waveguide 106 is simply disposed in the central portion of the planar horn antenna 202 in order to effect a coupling. Furthermore, the planar horn antenna 202 is characterized by high pass frequency response (i.e. high pass filtering) and is preferably configured to be relatively compact for its directivity, and to exhibit device properties such as high gain, directivity, and acceptable losses over most of the intended range of operating frequencies. The compactness feature is useful for convenient attachment to the IC 104, when the planar horn antenna 202 exists as a separate component. Additionally, the waveguide coupler 200 is configured to match the frequency response of the dielectric waveguide 106 to ensure optimal device interoperability.

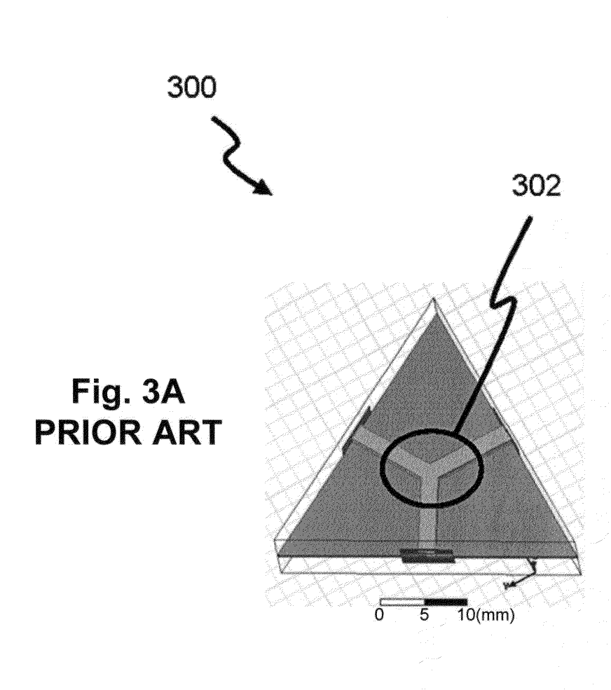

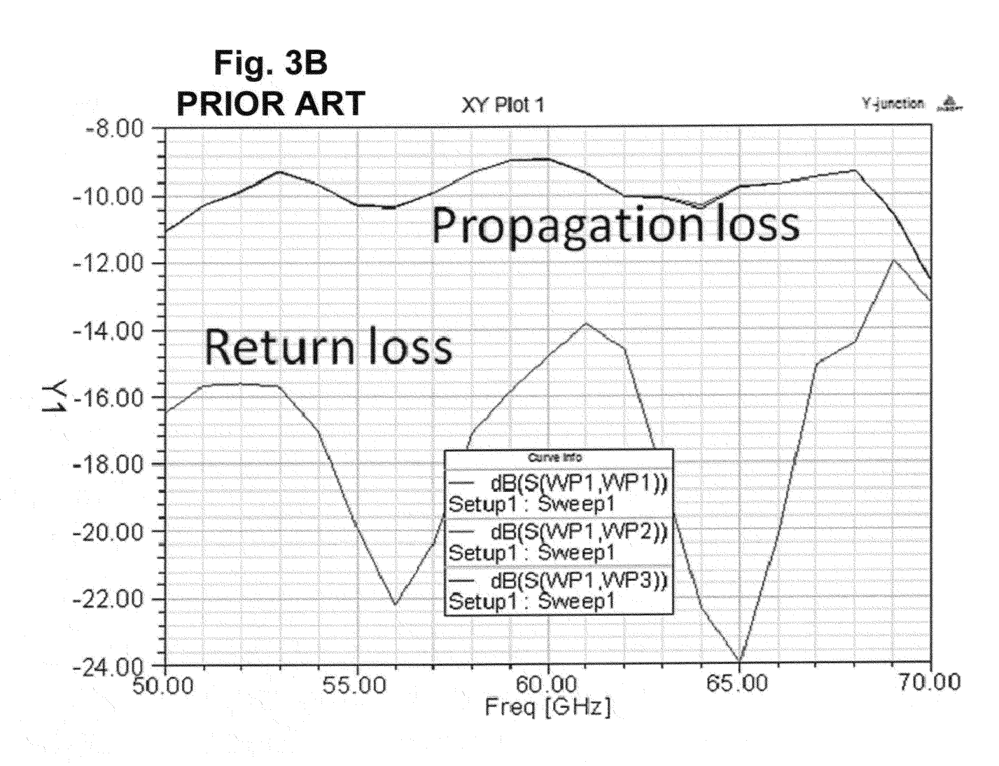

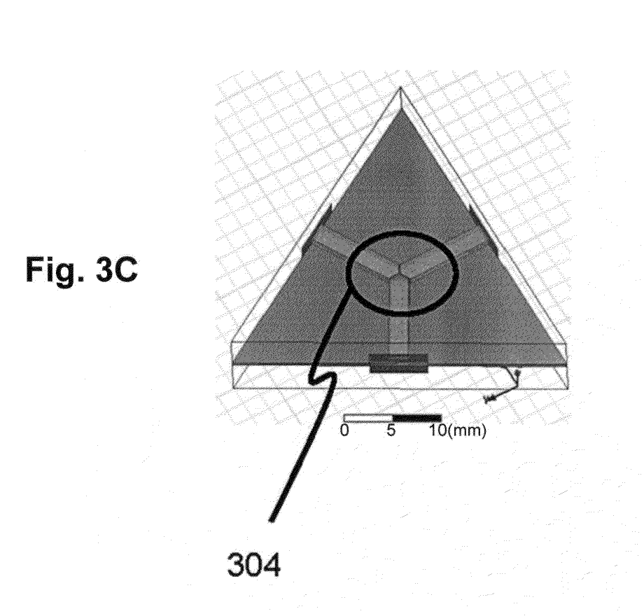

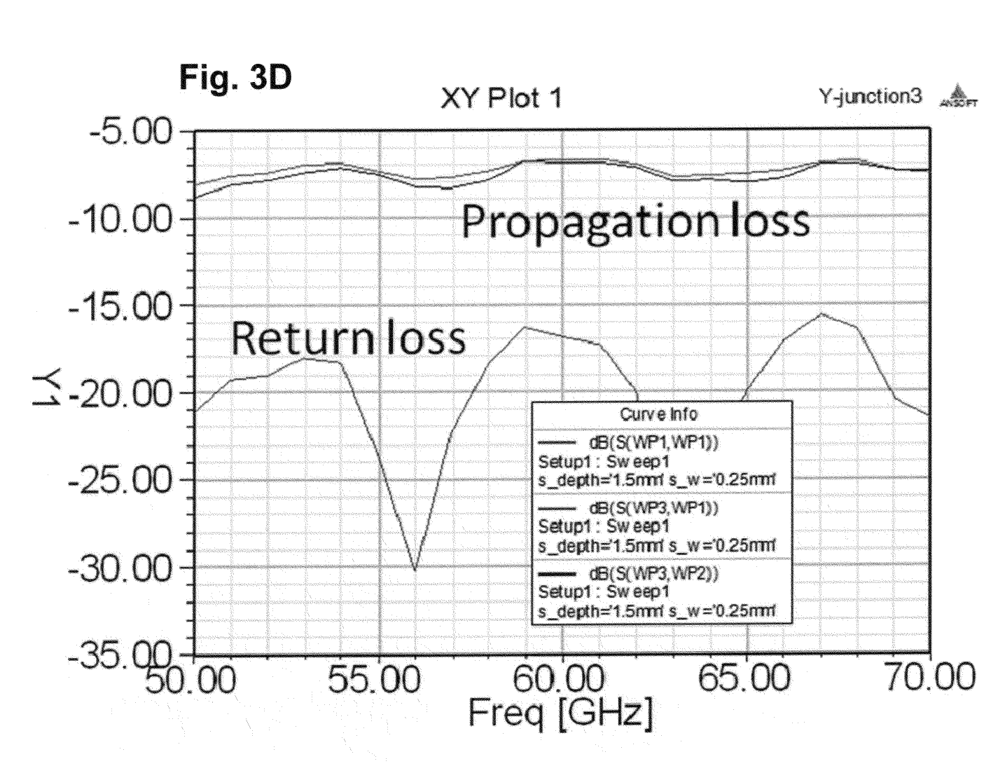

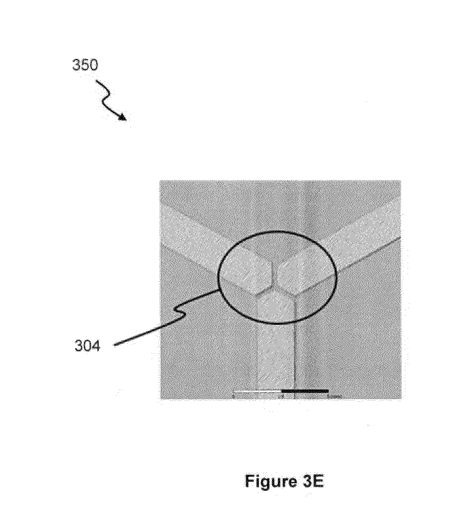

As illustrated in FIG. 1, the dielectric waveguide 106 is formed from a plurality of discrete sections, and coupled together at the signal junctions 108 (i.e. arranged as Y-junctions 108), where signals may be split or combined. Alternatively, the dielectric waveguide 106 may also be formed of a single contiguous portion, depending on the topology type prescribed for the network 100. It is to be appreciated that any discrete section on the network 100 that is not coupled to an IC 104 needs to be terminated using a signal terminator (not shown) to prevent signal reflection, which would otherwise cause interference. With reference to a conventional Y-junction 302 illustrated in FIG. 3A, there will typically be detectable signal losses when signals are bifurcated at a junction 108 due to the sudden change in the geometric dimension, consequently triggering an impedance change in the dielectric waveguide 106 at that section, which would result in undesired electromagnetic wave reflection and radiation. The associated signal loss performances of the conventional Y-junction 302 due to this observed phenomenon are depicted in the chart of FIG. 3B, which shows that the return loss of each discrete section and the propagation loss between any two sections, are considerably large thereby substantially affecting performance.

Therefore, to minimize the signal loss incurred due to signal splitting, a slotted Y-junction 304, as shown in FIG. 3C, is proposed and adapted for use in the network 100 of FIG. 1. Specifically, all discrete sections (i.e. sub-branches) of the slotted Y-junction 304 are each configured to have a substantially similar symmetrically-shaped structure at the end (i.e. arrowhead shaped) arranged to meet ends of other sections of the associated junction 108. By avoiding abrupt change to the shape of the waveguide path 106, unwanted signal loss effects seen in the conventional design are beneficially mitigated. This configuration also further simplifies the design and fabrication of the junction 108 (e.g. allows easy assembly of the waveguide path 106 for complex networks). Accordingly in this manner, the signal transmitted at a particular section of a junction 108 can be symmetrically split (i.e. to achieve an even split ratio) and propagated to other sections and vice-versa, signals from other sections of the junction 108 can be combined in a converse manner for transmission to a destination section, with a reduced loss rate.

To further improve performance, the slotted Y-junction 304 is configured such that there are narrow gaps (as shown in an enlarged view in FIG. 3E) arranged between the adjacent discrete sections at the junction point where they congregate. These discontinuities may reduce the mutual coupling effect between the discrete sections, thereby further eliminating signal reflection and radiation. Preferably, the width of each gap is approximately ten percent of the wavelength of a signal frequency transmitted through the dielectric waveguide 106. FIG. 3D shows the associated signal loss performance of the slotted Y-junction 304. In comparison with the conventional Y-junction 302 (as illustrated in FIG. 3B), it may be observed that both the return loss and signal loss for the slotted Y-junction 304 are considerably improved.

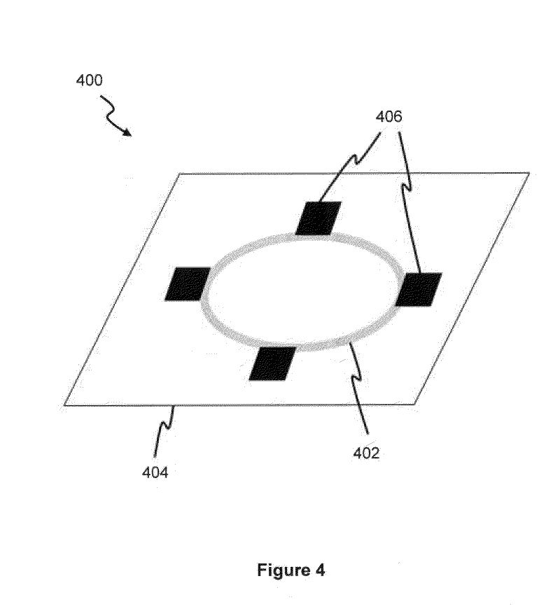

Another embodiment shown in FIG. 4 illustrates a waveguide network 400 arranged as a ring topology. This network 400 comprises a dielectric waveguide configured as a loop 402 on the PCB 404 and a plurality of ICs 406 coupled (via respective waveguide couplers 200) at different points along the loop 402. Since the loop 402 is formed as a single contiguous waveguide path, there is no necessity that the loop 402 include signal terminators or be configured with signal junctions 108, as may be the case for the bus-topology network 100 of FIG. 1.

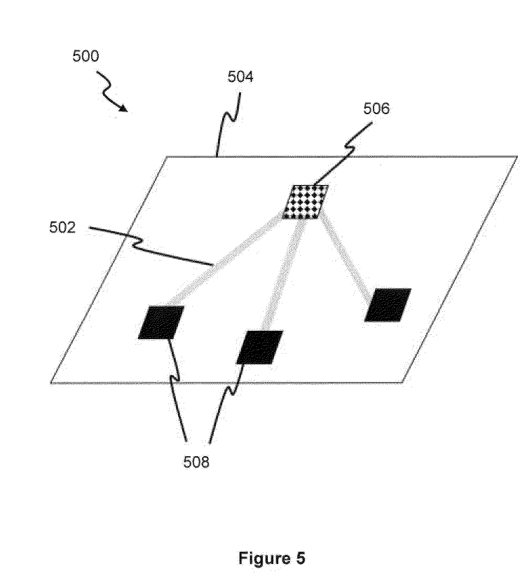

A further embodiment of a waveguide network 500, organized as a star-topology arrangement, is depicted in FIG. 5. Under this arrangement, the network 500 comprises a plurality of discrete dielectric waveguide sections 502 on the PCB 504, all centrally connected through a network hub 506. One end of each section 502 is coupled to an IC 508 and the opposing end is connected to the network hub 506. Therefore, all the ICs 508 are indirectly linked together by the network hub 506, being the common connection point. The network hub 506 preferably provides functionalities such as acting as a signal repeater (which may also include signal boosting), detecting signal collisions (which may include forwarding a jam signal to all ICs 506 if a collision is detected) and the like. Advantages to the star-topology network 500 include (but are not limited to) preventing non-centralized failure from affecting the network 500 (due to inherent isolation of each IC 508 by the discrete section connecting it to the network hub 506), enabling easy detection of faulty components, offering better performance by preventing unnecessary transmission of signals through excessive number of nodes (i.e. ICs 506), and allowing relatively easy upgrading of network capabilities (e.g. increasing hub capacity or connecting additional ICs 506) due to its highly extensible characteristic.

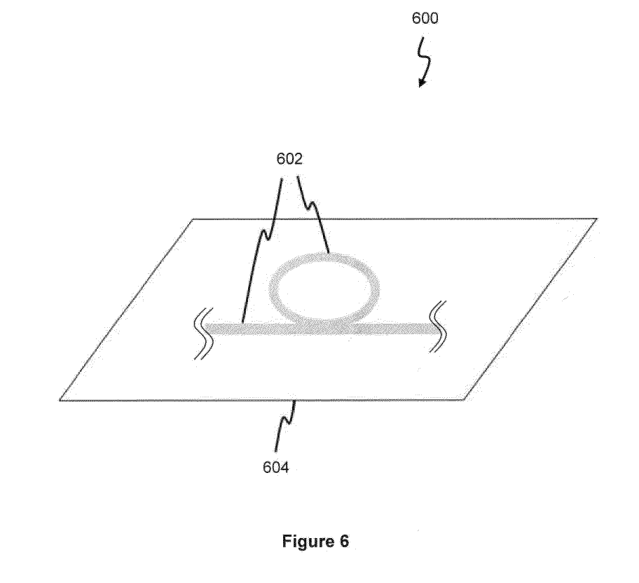

The network hub 506 may also incorporate a waveguide resonator 600 as depicted in FIG. 6 for signal amplification purposes (if it provides signal boosting). The waveguide resonator 600 comprises arranging the dielectric waveguide portions 902 to form an enclosure or cavity (e.g. a ring) on the PCB 604 as is illustrated. Energies of the transmitted electromagnetic signals are subsequently stored within this volume to establish a resonance condition, which amplifies the signals. It is also preferred that the network hub 506 incorporates a reasonable range of differently configured resonators (not shown) to handle diverse frequencies if the star-topology network 500 is connected to external networks. In addition, waveguide resonators are typically categorized based on the quality factor, Q, where the sharpness in the frequency response of a resonator increases with an increase in the Q-factor. It is therefore desirable that the waveguide resonator 600 is configured with a high-Q factor.

Not restricted to the foregoing described embodiments, the dielectric waveguide 106 may alternatively be configured such that networks (comprising the ICs 104) of other topology types such as mesh, fully-connected, line, and tree based (all not shown) are also realizable.

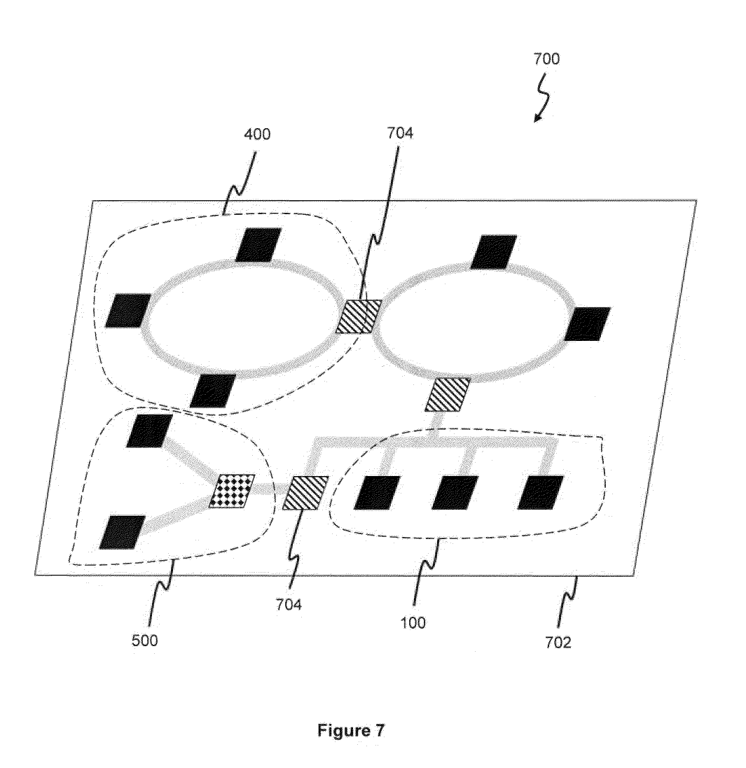

FIG. 7 shows a hybrid network 700 (on a PCB 702) formed by combining the bus-topology network 100 of FIG. 1, ring-topology network 400 of FIG. 4, and star-topology network 500 of FIG. 5. More particularly, the various networks 100, 400, 500 are inter-coupled, preferably, using network bridges 704. It is to be appreciated that in this configuration, the network hub 506 provides a point of connection for the star-topology network 500 to other miscellaneous networks 100, 400. Network bridges 704 are advantageous for interconnecting diverse networks as they may provide collision domain isolation (via micro-segmentation), and enable bandwidth scaling as the network 700 expands. Alternatively, other types of devices (e.g. network routers) for connecting multiple network segments at the data-link layer (i.e. Layer Two) or network layer (i.e. Layer Three) may also be used in place of the network bridges 704.

Matching devices known as “irises” (not shown) or equivalently configured circuits may be included into the hybrid network 700 for impedance matching the respective networks 100, 400, 500 to the respective loads (i.e. other connected networks). In particular, an iris is used to introduce capacitance (i.e. act as a shunt capacitive reactance), inductance (i.e. act as a shunt inductive reactance) or a combination of both into a waveguide to reduce induced signal reflections due to a mismatch between the waveguide and the load, which may otherwise result in malperformance issues such as power loss, reduction in power-handling capability and an increase in frequency sensitivity.

Further, the network hub 506 of FIG. 5 and network bridges 704 of FIG. 7 are configured as passive, waveguide components. As commonly known in the art, passive and active components are respectively incapable and capable of power gain. According to an exemplary embodiment, the dielectric material used to form the network hub 506 and bridges 704 should preferably show no appreciable additional electromagnetic effect for switching or modulation, and should be relatively insensitive to temperature drifts in order to ensure operational stability of the hybrid network 700.

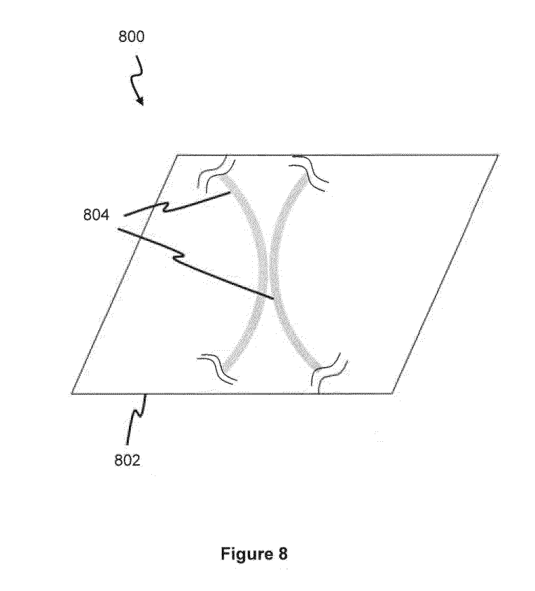

FIG. 8 shows a circuit implementation of a network bridge 800 used in the hybrid network 700. The network bridge 800, formed on a PCB 802, consists of two adjacently arranged dielectric waveguide portions 804. A device having such an arrangement is known as an inter-coupled waveguide. Preferably, the inter-coupled waveguide is configured as a 4-port coupler, wherein a signal being relayed is coupled to one half of the waveguide portions 804 and also transmitted to the other half. The coupling strength of the network bridge 800 may be altered by adjusting the gap width between the waveguide portions 804.

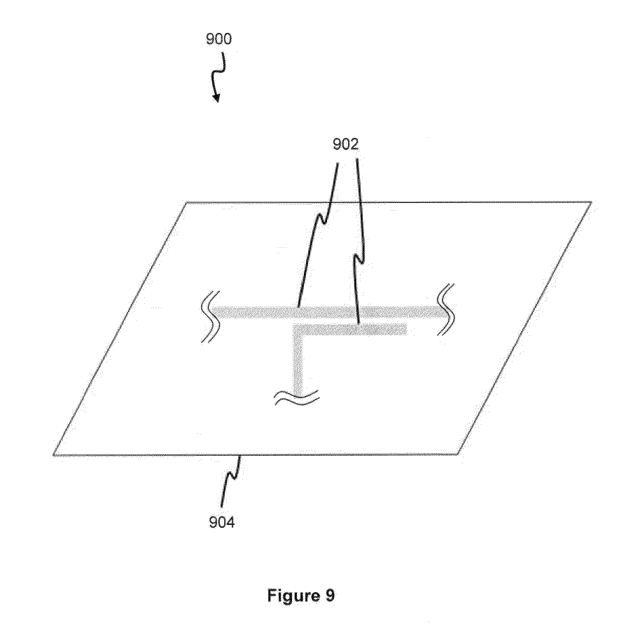

FIG. 9 depicts an alternative circuit implementation of a network bridge 900 for use in the hybrid network 700. Specifically, the dielectric waveguide portions 902 on the PCB 904 are arranged as an end-coupled waveguide. In one embodiment, the end-coupled waveguide is configured as a 3-port coupler, wherein the energy of the signal to be relayed can be transmitted equally among all sections of the waveguide portions 902. Moreover, in order to avoid the use of a signal terminator in this configuration, it is to be appreciated that the coupling length of the waveguide portions 902 is approximately a quarter wavelength of the transmitted signal frequency or a multiple thereof.

While the invention has been illustrated and described in detail in the drawings and foregoing description, such illustration and description are to be considered illustrative or exemplary, and not restrictive; the invention is not limited to the disclosed embodiments.

Other variations to the disclosed embodiments can be understood and effected by those skilled in the art in practicing the claimed invention. In the claims, the term “comprising” does not exclude other elements or steps and the indefinite article “a” or “an” does not exclude a plurality. The mere fact that certain measures are recited in different dependent claims does not mean that a combination of these measures cannot be used to advantage.

1. A waveguide network or waveguide bus, comprising:
a substrate having a plurality of integrated circuits disposed thereon; and
a dielectric waveguide on or in, the substrate,
wherein the plurality of integrated circuits are coupled via the dielectric waveguide.

2. The waveguide network or waveguide bus according to claim 1, wherein the dielectric waveguide is configured for transmission of radio frequency signals.

3. The waveguide network or waveguide bus according to claim 1, wherein the dielectric waveguide is configured to have a bandwidth of at least 100 GHz.

4. The waveguide network or waveguide bus according to claim 1, wherein the dielectric waveguide is arranged to interconnect the plurality of integrated circuits to form a network, the network being configured with a ring topology, a star topology or a bus topology.

5. The waveguide network or waveguide bus according to claim 4, further comprising:
a network hub disposed on the substrate to centrally interconnect the plurality of integrated circuits, when the network is configured with the tree topology.

6. The waveguide network or waveguide bus according to claim 5, wherein the network hub is a passive waveguide component comprising a waveguide resonator providing signal amplification.

7. The waveguide network or waveguide bus according to claim 4, wherein the network is communicably couplable to other equivalently configured networks on the substrate using network bridges.

8. The waveguide network or waveguide bus according to claim 7, wherein each network bridge is a passive waveguide component arranged as an inter-coupled waveguide or an end-coupled waveguide.

9. The waveguide network or waveguide bus according to claim 7, wherein the dielectric waveguide, network hub and network bridges are formed on the substrate using a fabricating method being one of printing, injection stamping, and etching.

10. The waveguide network or waveguide bus according to claim 1, wherein the dielectric waveguide comprises a plurality of discrete sections and at least one junction having a plurality of gaps at which the discrete sections congregate.

11. The waveguide network or waveguide bus according to claim 10, wherein the width of each gap is approximately ten percent of the wavelength of a signal frequency transmitted through the dielectric waveguide.

12. The waveguide network or waveguide bus according to claim 1, wherein each integrated circuit is coupled to the dielectric waveguide via a waveguide coupler.

13. The waveguide network or waveguide bus according to claim 12, wherein the waveguide coupler is configured as a planar horn antenna.

14. The waveguide network or waveguide bus according to claim 2, wherein the dielectric waveguide is configured to permit the radio frequency signals to be transmitted concurrently and/or serially.

15. The waveguide network or waveguide bus according to claim 1, wherein the substrate is a printed circuit board.

16. A waveguide network or waveguide bus comprising:
a printed circuit board having a plurality of integrated circuits disposed thereon; and
a dielectric waveguide on or in, the printed circuit board,
wherein the plurality of integrated circuits are coupled via the dielectric waveguide.

17. A dielectric waveguide configured to be attached to the surface of, or integrated into, a substrate, the dielectric waveguide comprising:
a first end arranged to be connectable to an integrated circuit disposed on the substrate; and
a second end arranged to be connectable to another equivalent dielectric waveguide.
